(19) United States
(12) Patent Application Publication
(10) Pub. No.: US 2013/0248222 A1
(43) Pub. Date: Sep. 26, 2013

(54) COAXIAL CABLE AND PRODUCTION METHOD FOR A COAXIAL CABLE

(71) Applicants: Tsutomu Inaba, Oume-shi (JP); Hiroshi Shinozaki, Oume-Shi (JP)

(72) Inventors: Tsutomu Inaba, Oume-shi (JP); Hiroshi Shinozaki, Oume-Shi (JP)

(21) Appl. No.: 13/655,739

(22) Filed: Oct. 19, 2012

(30) Foreign Application Priority Data
Mar. 26, 2012 (JP) 2012-070192

(51) Int. Cl. H01B 9/02; H01B 13/016

(52) U.S. Cl. 174/107; 427/118

(57) ABSTRACT

A coaxial cable according to this embodiment includes: a center conductor; an insulating layer that coats the center conductor; an outer conductor that coats the insulating layer; and an insulating coating film that coats the outer conductor. The insulating layer has, at least one end portion thereof, an outer diameter smaller than an outer diameter of other portions thereof.

### CROSS-REFERENCE TO RELATED APPLICATION

This application is based upon and claims the benefit of priority from the prior Japanese Patent Application No. 2012-070192, filed on Mar. 26, 2012; the entire contents of which are incorporated herein by reference.

### FIELD

Embodiments described herein relate generally to a coaxial cable and a production method for a coaxial cable.

### BACKGROUND

A conventional imaging apparatus includes a head separated imaging apparatus. The head separated imaging apparatus includes a head unit and a main unit that are separated from each other. The head unit includes an image sensor (e.g., charge coupled device (CCD) image sensor or complementary metal oxide semiconductor (CMOS) image sensor). The main unit processes an image signal sent from the head unit. The head unit and the main unit are connected to each other via a camera cable in the head separated imaging apparatus. The camera cable houses a plurality of coaxial cables. Data is sent and received between the head unit and the main unit via the coaxial cables. Further, various coaxial cables have been conventionally proposed for such data sending and reception.

By the way, in recent years, downsizing of the head unit of the head separated imaging apparatus is desired. Also, arrangement intervals of connection terminals of the head unit are reduced. Therefore, it has been difficult to connect a center conductor of each of the coaxial cables housed in the camera cable to each of the connection terminals of the head unit. In view of this, it is assumed that the thickness of an insulating layer that coats the center conductor is reduced, to thereby thin the coaxial cable. However, there is a fear that thinning the insulating layer may make it difficult to maintain characteristic impedance (e.g., 75Ω) required for the coaxial cable.

### BRIEF DESCRIPTION OF THE DRAWINGS

FIG. 1 is a configuration diagram of an imaging apparatus according to an embodiment.

FIG. 2 is an overhead view of a head unit and a camera cable according to the embodiment.

FIG. 3A is a side view of one of coaxial cables according to the embodiment.

FIG. 3B is a front view of the coaxial cable according to the embodiment.

FIG. 4 is a diagram for explaining characteristic impedance of the coaxial cable.

FIG. 5A is a view (plan view) showing connections of the coaxial cables according to the embodiment.

FIG. 5B is a view (side view) showing the connections of the coaxial cables according to the embodiment.

FIG. 6 shows an example of conventional coaxial cables.

FIGS. 7A and 7B show a different example of the conventional coaxial cables.

FIG. 8A to 8C are front views of coaxial cables according to modified examples of the embodiment.

### DETAILED DESCRIPTION

A coaxial cable according to an embodiment includes: a center conductor; an insulating layer that coats the center conductor; an outer conductor that coats the insulating layer; and an insulating coating film that coats the outer conductor. The insulating layer has, at least one end portion thereof, an outer diameter smaller than at other portions thereof.

Hereinafter, an embodiment will be described with reference to the drawings.

### Embodiment

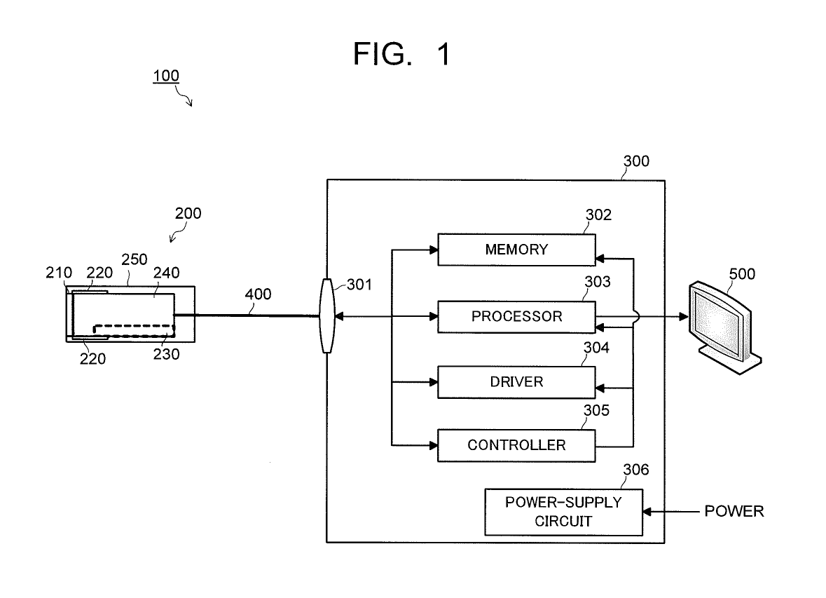

FIG. 1 is a configuration diagram of an imaging apparatus 100 according to an embodiment (hereinafter, referred to as imaging apparatus 100). The imaging apparatus 100 is, for example, an endoscopic apparatus. The imaging apparatus 100 includes a head unit 200, a camera control unit (CCU) 300, and a camera cable 400 that connects the head unit 200 and the CCU 300 to each other.

The head unit 200 includes an image sensor 210, a tape automated bonding (TAB) device 220 (wiring board), a circuit board 230, a base 240, and a casing 250. The image sensor 210 is, for example, a solid-state image sensor such as a complementary metal oxide semiconductor (CMOS) image sensor or a charge coupled device (CCD) image sensor.

The TAB device 220 is one that has a circuit formed on a heat-resistant film by etching. The TAB device 220 is connected to the image sensor 210 via a bump or a bonding pad.

A driver circuit for the image sensor 210 (e.g., circuit for amplifying output) is mounted on the circuit board 230. The circuit board 230 is connected to terminals of the TAB device 220 and to a wiring of the camera cable 400.

The base 240 is provided with the image sensor 210, the TAB device 220, and the circuit board 230. The casing 250 houses the base 240 provided with the TAB device 220 on which the image sensor 210 is mounted.

The CCU 300 includes an interface (IF) circuit 301, a memory 302, a processor 303, a driver 304, a controller 305, and a power-supply circuit 306.

The IF circuit 301 is an interface for sending and receiving a control signal and data to/from the head unit 200. The memory 302 is a non-volatile memory, for example, an electrically erasable programmable read-only memory (EEPROM). The memory 302 stores setting data (operation mode) and correction data for the head unit 200.

The processor 303 is a processor for processing an image. The processor 303 performs various corrections (e.g., noise correction, white balance correction, and γ correction) on an image signal sent from the head unit 200. The processor 303 outputs the image signal after the corrections to an external display apparatus 500 (e.g., cathode ray tube (CRT) monitor or liquid-crystal monitor).

The driver 304 is a driver circuit for the image sensor 210. The driver 304 changes a drive system or a frame rate of the image sensor 210 according to control by the controller 305. Further, the driver 304 outputs a pulse signal (e.g., vertical synchronous pulse signal or horizontal synchronous pulse signal (transfer pulse signal, reset gate pulse signal)) to the image sensor 210.

The controller 305 reads out the correction data and the setting data from the memory 302. The controller 305 controls the processor 303 and the driver 304 based on the read-out correction data and setting data.

The power-supply circuit 306 is connected to an external power supply. The power-supply circuit 306 converts an electric power from the external power supply into a predetermined voltage and supplies it to circuit components (IF circuit 301, memory 302, processor 303, driver 304, and controller 305) of the CCU 300. Further, the electric power from the power-supply circuit 306 is also supplied to the head unit 200 via the camera cable 400.

### (Configuration in Head Unit 200)

FIG. 2 is an overhead view of the head unit 200 and the camera cable 400. It should be noted that, since the base 240 hides the circuit board 230, the circuit board 230 is not shown in FIG. 2. Further, the casing 250 of the head unit 200 is not shown in FIG. 2. As shown in FIG. 2, the image sensor 210 is provided to an end surface 240A of the base 240 of the head unit 200 in such a state that the image sensor 210 is mounted on the TAB device 220. The TAB device 220 on which the image sensor 210 is mounted is fixed on the base 240 in such a state that the TAB device 220 is folded along a top surface 240B and a bottom surface 240C of the base.

The TAB device 220 is provided with a plurality of terminals 221 for connecting to a plurality of cables 410 housed in the camera cable 400. Some of the terminals 221 are connected to not the cables 410 but terminals of the circuit board 230 (not shown).

The camera cable 400 houses the plurality of cables 410 for, e.g., data signal (image signal) transmission, synchronous signal (vertical synchronous pulse signal and horizontal synchronous pulse signal) transmission, bias voltage application, electric power supply, and ground (GND). The cables 410 for data transmission and synchronous signal transmission out of the cables 410 housed in the camera cable 400 are coaxial cables (hereinafter, referred to as coaxial cables 410).

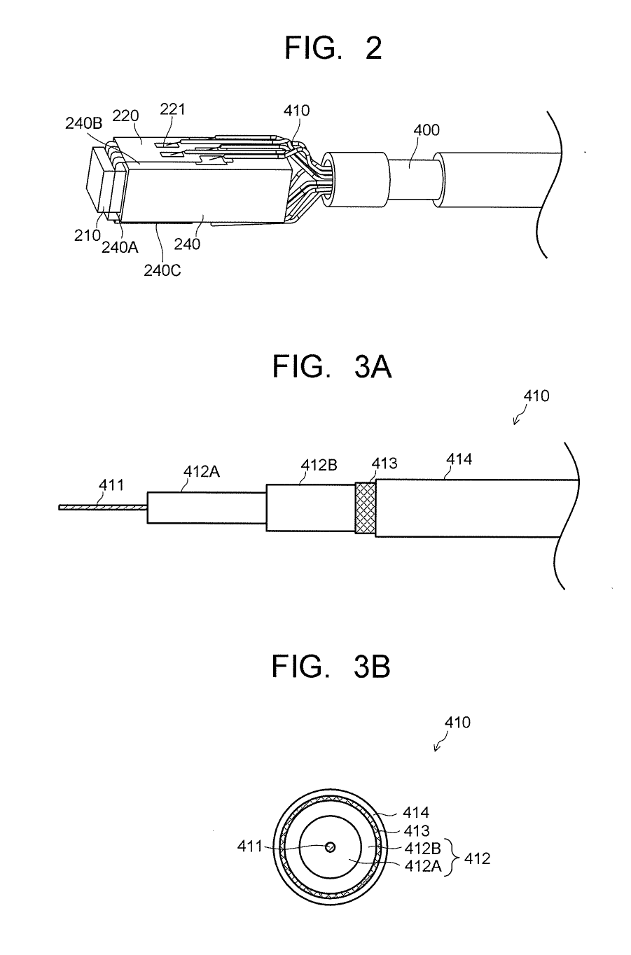

FIG. 3A is a side view of one of the coaxial cables 410. FIG. 3B is a front view of the coaxial cable 410. As shown in FIGS. 3A and 3B, the coaxial cable 410 includes a center conductor 411, an insulating layer 412 that coats the center conductor 411, an outer conductor 413 that coats the insulating layer 412, and an insulating coating film 414 that coats the outer conductor 413.

The center conductor 411 is constituted of a twisted wire material obtained by twisting a plurality of conductive wire (e.g., solid wire made of Cu-2 mass % Ag alloy wire) materials together. The center conductor 411 transmits a data signal (image signal), a synchronous signal, and the like. It should be noted that it is also possible to use not the twisted wire material but a single conductive wire for the center conductor 411.

The insulating layer 412 includes a first insulating layer 412A and a second insulating layer 412B. The first insulating layer 412A and the second insulating layer 412B are each constituted of a dielectric insulating material (e.g., Teflon (registered trademark) or polyester). The first insulating layer 412A coats an outer periphery of the center conductor 411. The second insulating layer 412B, in turn, coats an outer periphery of the first insulating layer 412A. It should be noted that a material having a higher heat resistance than the second insulating layer 412B is preferably used for the first insulating layer 412A. It is for the purpose of preventing fusion of the first insulating layer 412A and the second insulating layer 412B when the outer periphery of the first insulating layer 412A is coated with the second insulating layer 412B.

The outer conductor 413 is a braided shield obtained by braiding thin metal wires (e.g., copper wires) called braided wires or a served shield obtained by winding the thin metal wires transversely. It should be noted that a metal foil may be used for the outer conductor 413 in order to carry out accurate measurement or suppress attenuation at a frequency equal to or higher than an ultra high frequency. The outer conductor 413 is connected (grounded) to ground (GND) on the CCU 300 side.

The insulating coating film 414 is constituted of an insulating material (e.g., polyethylene). The insulating coating film 414 coats an outer periphery of the outer conductor 413. The insulating coating film 414 insulates the coaxial cable 410 and functions also as a protective coating film.

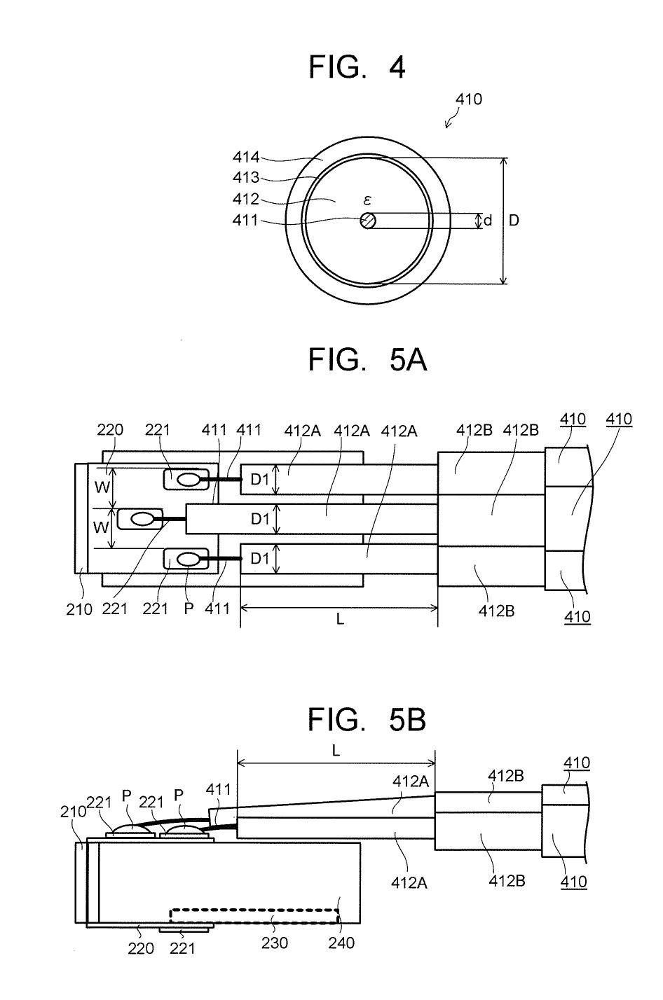

FIG. 4 is a diagram for explaining characteristic impedance of the coaxial cable 410. As shown in FIG. 4, provided that a diameter (outer diameter) of the center conductor 411 is denoted by d, a diameter (outer diameter) of the insulating layer 412 is denoted by D, and a relative permittivity of the insulating layer 412 is denoted by ∈, the characteristic impedance Z0 (Ω) of the coaxial cable 410 is expressed by Expression (1) below.

$${Z}_{0} = \frac{60}{\sqrt{ɛ}} {Log}_{ɛ} \frac{D}{d} 3 \qquad ( 1 )$$

By the way, in recent years, the head unit 200 that connects to the camera cable 400 has become smaller. Therefore, as mentioned above, there is a need for thinning each of the coaxial cables 410 housed in the camera cable 400. However, the characteristic impedance Z0 of the coaxial cable is generally set to 50Ω or 75Ω. In other words, the characteristic impedance of the coaxial cable 410 cannot be changed.

Therefore, reducing the diameter d of the center conductor 411 or reducing the thickness of the insulating layer 412 while using a material having a high relative permittivity ∈ (e.g., porous polyethylene) as the material of the insulating layer 412 is assumed from the above Expression (1) in order to thin the coaxial cables 410. However, the diameter d of the center conductor 411 is already reduced sufficiently and it is very difficult to further reduce it in terms of electric resistance and strength. In addition, in the case where the material having a high relative permittivity ∈ (e.g., porous polyethylene) is used as the material of the insulating layer 412, problems are caused in terms of strength and flexibility.

FIGS. 5A and 5B are views showing connections of the center conductors 411 of the coaxial cables 410 to the terminals 221 of the TAB device 220. FIG. 5A is a plan view and FIG. 5B is a side view. It should be noted that FIG. 5 each show, for the sake of description, a case where the three coaxial cables are connected to the terminals 221 of the TAB device 220.

As shown in FIG. 5, each of the coaxial cables 410 in this embodiment is configured to be easily connected to each of the terminals 221 of the TAB device 220 by stripping the second insulating layer 412B at an end portion of the coaxial cable 410 on the head unit 200 side, to thereby reduce a diameter (outer diameter) at the end portion of the coaxial cable 410. The center conductor 411 of each of the coaxial cables 410 is electrically connected to each of the terminals 221 of the TAB device 220 with a solder P. Alternatively, another method (e.g., silver (Ag) paste) may be used to electrically connect the center conductor 411 of each of the coaxial cables 410 to each of the terminals 221 of the TAB device 220.

It should be noted that the first insulating layer 412A constituting the insulating layer 412 preferably has a diameter (outer diameter) D1 equal to or smaller (shorter) than each of arrangement intervals W of the terminals 221 in order to easily connect the center conductors 411 of the coaxial cables 410 to the terminals 221 of the TAB device 220. Further, a stripping length of the second insulating layer 412B of the insulating layer 412 is preferably set to about 5 mm for the purpose of suppressing fluctuations of characteristic impedance of the coaxial cable 410.

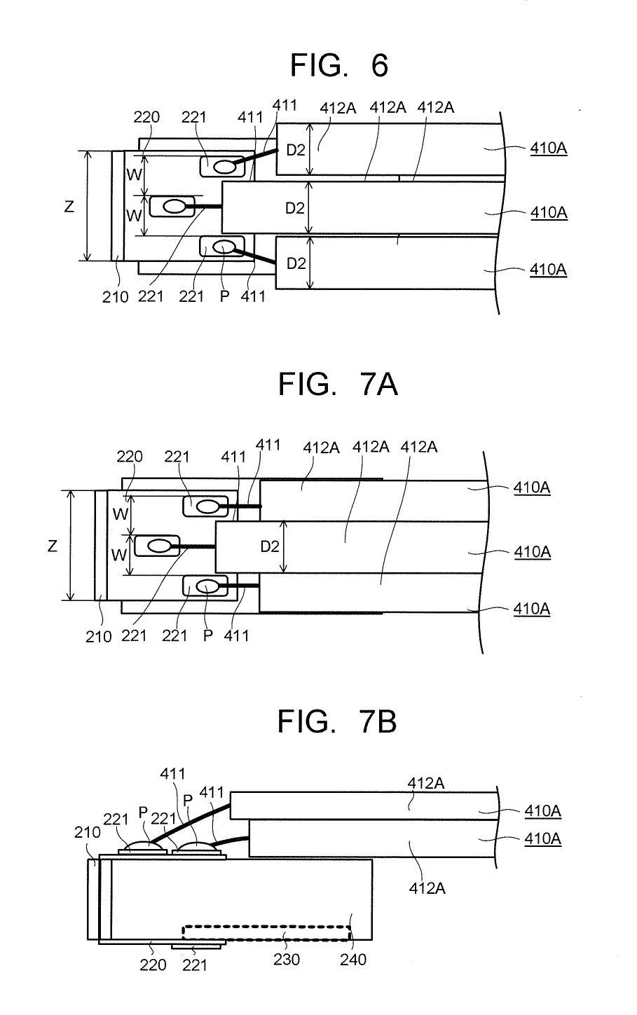

An example in which coaxial cables 410A housed in a conventional camera cable 400A are connected to terminals 221 of a TAB device 220 is shown in FIG. 6. An insulating layer 412 at an end portion of each of the conventional coaxial cables 410A on a head unit 200 side is not thinned. Thus, the insulating layer 412 has a diameter (outer diameter) D2 larger (longer) than each of arrangement intervals W of the terminals 221 of the TAB device 220.

Therefore, even if connection of the terminal 221 of the TAB device 220 is tried in such a state that the coaxial cables 410A are arranged in parallel, the position of a center axis of the coaxial cable 410A and the position of the terminal 221 of the TAB device 220 are misaligned with each other. Therefore, it is difficult to easily connect the center conductors 411 of the coaxial cables 410A to the terminals 221 of the TAB device 220. In addition, since a width (D2×3) of the arranged coaxial cables 410A is larger than a width Z of the base 240, the coaxial cables 410A arranged at the both ends protrude from the base 240. Therefore, it becomes difficult to downsize the head unit 200.

Another example in which coaxial cables 410A housed in a conventional camera cable 400A are connected to terminals 221 of a TAB device 220 is shown in FIGS. 7A and 7B. FIG. 7A is a plan view and FIG. 7B is a side view. As shown in FIGS. 7A and 7B, when the coaxial cables 410A are arranged to be deviated from each other in upper and lower directions such that the coaxial cables 410A arranged at both ends do not protrude from the base 240, the entire thickness is increased in turn. Consequently, it becomes difficult to downsize the head unit 200.

Also regarding the soldering, it is necessary to connect the center conductor 411 of the upper coaxial cable 410 (arranged in middle) after connections of the center conductors 411 of the lower coaxial cables 410A (arranged at both ends). Therefore, it is difficult to easily connect the center conductors 411 of the coaxial cables 410A to the terminals 221 of the TAB device 220.

As described above, it has been difficult to downsize the head unit 200 in the conventional coaxial cables 410A. However, as shown in FIG. 5, the diameter (outer diameter) at the end portion of the coaxial cable 410 is reduced by stripping the second insulating layer 412B at the end portion of the coaxial cable 410 on the head unit 200 side in the coaxial cables 410 according to this embodiment. Therefore, it is possible to easily connect each of the coaxial cables 410 to each of the terminals 221 of the TAB device 220 of the downsized head unit 200. Further, since the second insulating layer 4128 at the end portion of the coaxial cable 410 is stripped by only about 5 mm, no problems of characteristic impedance are caused regarding a signal having a band frequency of 1 GHz or less.

### (Production of Camera Cable 400)

Next, a production method for the camera cable 400 will be described with reference to FIGS. 3A and 3B. First, a polyester to be the first insulating layer 412A is welded to an outer periphery of the twisted wire material obtained by twisting a plurality of conductive wire (e.g., solid wire made of Cu-2 mass % Ag alloy wire) materials together, the twisted wire material being to be the center conductor 411, so that the center conductor 411 is coated with the first insulating layer 412A. At this time, it should be noted that the diameter (outer diameter) D1 of the first insulating layer 412A is set to be smaller than each of the arrangement intervals W of the terminals 221 of the TAB device 220.

Subsequently, a polyester to be the second insulating layer 412B is welded to the outer periphery of the first insulating layer 412A, so that the first insulating layer 412A is coated with the second insulating layer 412B. It should be noted that a material having a higher heat resistance than the second insulating layer 412B is preferably used for the first insulating layer 412A.

Subsequently, an outer periphery of the insulating layer 412 constituted of the first insulating layer 412A and the second insulating layer 412B is coated with a braided shield obtained by braiding thin metal wires (e.g., copper wires) called braided wires or a served shield obtained by winding the thin metal wires transversely, the braided shield or the served shield being to be the outer conductor 413. It should be noted that the outer periphery of the insulating layer 412 may be coated with a metal foil as the outer conductor 413 instead of the braided shield or the like in order to carry out accurate measurement or suppress attenuation at a frequency equal to or higher than an ultra high frequency. The outer conductor 413 is connected (grounded) to ground (GND) on the CCU 300 side.

Subsequently, an outer periphery of the outer conductor 413 is coated with the insulating material (e.g., Teflon (registered trademark) or polyethylene) to be the insulating coating film 414. In this manner, the coaxial cables 410 are prepared.

Subsequently, the insulating coating film 414, the outer conductor 413, and the second insulating layer 412B of each of the coaxial cables 410 are, on one end side of the coaxial cable 410, stripped by approximately 5 to 7 mm from the end portion thereof by the use of a tool such as a stripper, so that the first insulating layer 412A is exposed. Subsequently, the exposed first insulating layer 412A is stripped by approximately 1 to 2 mm from the end portion thereof by the use of the tool such as the stripper, so that the center conductor 411 is exposed.

As described above, the diameter (outer diameter) at the end portion of each of the coaxial cables 410 according to this embodiment is reduced by stripping the second insulating layer 412B at the end portion of the coaxial cable 410 on the head unit 200 side. Therefore, it is possible to easily connect each of the coaxial cables 410 to each of the terminals 221 of the TAB device 220 of the downsized head unit 200. Further, since the second insulating layer 412B at the end portion of the coaxial cable 410 is stripped by only about 5 mm, no problems of characteristic impedance are caused regarding a signal having a band frequency of 1 GHz or less.

It should be noted that, when the diameter (outer diameter) at the end portion of the coaxial cable 410 is reduced, the second insulating layer 412B at both end portions of the coaxial cable 410 may be stripped rather than stripping the second insulating layer 412B at only one end portion of the coaxial cable 410 on the connection side (one side) to the head unit 200.

### Modified Examples of Embodiment

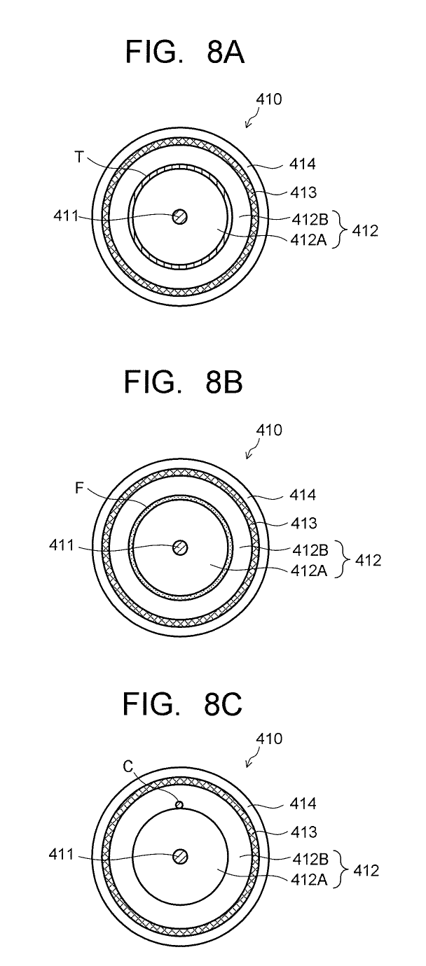

FIGS. 8A to 8C show modified examples of the embodiment. As shown in FIG. 8A, an outer periphery of a first insulating layer 412A may be coated with a fusion preventing tape T (e.g., heat-resistant tape) before coating of a second insulating layer 412B in order to prevent fusion of the first insulating layer 412A and the second insulating layer 412B. Alternatively, as shown in FIG. 8B, fusion preventing powder F may be applied to an outer periphery of a first insulating layer 412A before coating of a second insulating layer 412B in order to prevent fusion of the first insulating layer 412A and the second insulating layer 412B.

Alternatively, an outer periphery of a first insulating layer 412A may be coated with a second insulating layer 412B in such a state that a wire material C may be placed along a longitudinal direction of the first insulating layer 412A. In this case, when the second insulating layer 412B is stripped, it is possible to easily strip the second insulating layer 412B by pulling the wire material C. It should be noted that a material (e.g., iron wire) having enough strength to tear the second insulating layer 412B that coats the outer periphery of the first insulating layer 412A is used as the wire material C.

In addition, enameled wires may be used for the center conductor 411 and the first insulating layer 412A. In this case, since the first insulating layer 412A becomes very thin, pulling of the coaxial cables 410 and connection to the TAB device 220 (and/or the circuit board 230) become easy. Further, since the end portions of the coaxial cables 410 are further thinned, it is possible to further downsize the head unit 200.

### Other Embodiment

While certain embodiments have been described, these embodiments have been presented by way of example only, and are not intended to limit the scope of the inventions. Indeed, the novel embodiments described herein may be embodied in a variety of other forms; furthermore, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coaxial cable, comprising:
a center conductor;
an insulating layer configured to coat the center conductor;
an outer conductor configured to coat the insulating layer; and
an insulating coating film configured to coat the outer conductor, the insulating layer configured to have, at least one end portion thereof, an outer diameter smaller than at other portions thereof.

2. The cable according to claim 1,
wherein the insulating layer includes:
a first insulating layer configured to coat the center conductor; and
a second insulating layer configured to coat the first insulating layer, the second insulating layer configured to be stripped at the at least one end portion of the insulating layer.

3. The cable according to claim 2,
wherein the first insulating layer configured to be constituted of a material configured to have a melting point higher than the second insulating layer.

4. The cable according to claim 2, further comprising a fusion preventing layer configured to be formed between the first insulating layer and the second insulating layer to prevent fusion of the first insulating layer and the second insulating layer.

5. The cable according to claim 4,
wherein the fusion preventing layer configured to be constituted of one of fusion preventing powder and a heat-resistant tape.

6. The cable according to claim 1,
wherein the center conductor of the coaxial cable configured to be connected to any one of a plurality of terminals formed in a wiring board; and
wherein the coaxial cable configured to have, at an end portion thereof on a side to be connected to the terminal, an outer diameter smaller than each of arrangement intervals of the plurality of terminals.

7. A production method for a coaxial cable, comprising:
coating a center conductor with an insulating layer;
coating the insulating layer with an outer conductor;
coating the outer conductor with an insulating coating film; and
setting the insulating layer to have, at least one end portion thereof, an outer diameter smaller than at other portions thereof.

8. The method according to claim 7,
wherein the coating the center conductor with the insulating layer includes:
coating the center conductor with a first insulating layer; and
coating the first insulating layer with a second insulating layer.

9. The method according to claim 8, further comprising
stripping the second insulating layer at the at least one end portion of the insulating layer to set the insulating layer to have, at the at least one end portion, the outer diameter smaller than at the other portions thereof.

10. The method according to claim 8, further comprising
forming a fusion preventing layer between the first insulating layer and the second insulating layer to prevent fusion of the first insulating layer and the second insulating layer.

11. The method according to claim 7, further comprising
connecting the center conductor of the coaxial cable to any one of a plurality of terminals formed in a wiring board,
wherein the coaxial cable has, at an end portion thereof on a side to be connected to the terminal, an outer diameter smaller than each of arrangement intervals of the plurality of terminals.
